(19) United States
(12) Patent Application Publication
(10) Pub. No.: US 2024/0418229 A1
(43) Pub. Date: Dec. 19, 2024

(54) Actuator With Position Sensor

(71) Applicant: MARELLI EUROPE S.P.A., Corbetta (IT)

(72) Inventors: Stefano Verdelli, Corbetta (IT); Roberto Piciotti, Corbetta (IT); Stefano Musolesi, Corbetta (IT); Giovanni Stanzani, Corbetta (IT); Maurizio Marzullo, Corbetta (IT)

(73) Assignee: MARELLI EUROPE S.P.A., Corbetta (IT)

(21) Appl. No.: 18/741,422

(22) Filed: Jun. 12, 2024

(30) Foreign Application Priority Data
Jun. 16, 2023 (IT) 102023000012471

(51) Int. Cl. F16D 66/00; F16D 65/18; F16D 121/24; F16D 125/40; F16D 125/70

(52) U.S. Cl. CPC F16D 66/00; F16D 65/18; F16D 2066/003; F16D 2121/24; F16D 2125/40; F16D 2125/70

(57) ABSTRACT

An actuator comprising a body at least partially containing a control rod operatively connected to a motor and to an actuating device of a parking brake. The motor is configured to move the control rod along an operating stroke at least from a first position (A) to a second position (B). An antenna is directly and integrally associated with the control rod, and the antenna is located inside the body. A position sensor is arranged on a printed circuit, housed inside the body and faces the control rod and the antenna. The position sensor is configured to detect the presence and position of the antenna.

### CROSS-REFERENCE TO RELATED APPLICATIONS

The present application claims priority to and all the benefits of Italian Patent Application No. 102023000012471, filed on Jun. 16, 2023, the entire contents of which are hereby expressly incorporated herein by reference.

### BACKGROUND OF THE INVENTION

### 1. Field of the Invention

The present invention relates to an actuator, such as a linear actuator, provided with a position sensor, in particular for applications on parking brake modules in motor vehicles.

### 2. Description of the Related Art

In general, parking brake modules for motor vehicles comprise at least one actuator, typically of the linear type and equipped with a rod, with related kinematic mechanism, capable of placing the gearbox in the ‘parking’ position and then unlocking it.

The parking configuration must comply with the safety requirements of the vehicle, in particular, it must comply with the on-board diagnostics (OBD) of the vehicle; in other words, the electronics of the vehicle must always be capable of detecting possible malfunctions of the parking function.

The solutions of the prior art involve indirect measurement or estimation of the parking module configuration; in other words, the known solutions involve the use of sensors on the operating kinematic mechanism of the linear actuator, e.g., on a toothed wheel or pinion of such a kinematic mechanism. The on-board electronics can thus only estimate the position of the actuator and detect a possible anomaly by checking the angular position of the kinematic mechanism.

However, this type of indirect check is not entirely reliable and could, in some situations, lead to incorrect or untimely reports of possible malfunctions, for example if the failure occurs downstream of the kinematic mechanism monitored by the sensor.

Moreover, the solutions of the prior art are often mechanically complex and thus result in relatively high production costs.

In brief, the solutions of the prior art are expensive and not always reliable since they do not comply with the on-board diagnostics of the vehicle (OBD-compliant).

### SUMMARY OF THE INVENTION

The need is therefore felt to solve the drawbacks and limitations mentioned above with reference to the prior art. Such a need is met by an actuator comprising a body at least partially containing a control rod operatively connected to a motor and to an actuating device of a parking brake. The motor is configured to move the control rod along an operating stroke at least from a first position (A) to a second position (B). An antenna is directly and integrally associated with the control rod and the antenna is located inside the body. A position sensor is arranged on a printed circuit, housed inside the body and faces the control rod and the antenna. The position sensor is configured to detect the presence and position of said antenna.

### BRIEF DESCRIPTION OF THE DRAWINGS

Further features and advantages of the present invention will be more comprehensible from the following description of preferred embodiments thereof, given by way of non-limiting examples, in which:

FIG. 1 depicts a perspective view, in assembled configuration, of an actuator according to an embodiment of the present invention;

FIG. 2 depicts a perspective view, in an exploded configuration, of the actuator in FIG. 1;

FIG. 3 depicts a section view, in assembled configuration, of the actuator in FIG. 1;

FIG. 4 depicts a perspective view of the antenna and the position sensor of the actuator in FIG. 1;

FIG. 5 depicts a side view of the antenna and the position sensor in FIG. 4, from the side of the arrow V in FIG. 4;

FIGS. 6, 7, 8, and 9 depict side or plan views of an actuator with related sensor in different operating positions;

FIG. 10 depicts a perspective view of the antenna and the position sensor of an actuator according to a further embodiment of the present invention;

FIG. 11 depicts a side, partial section view of the antenna and the position sensor in FIG. 10;

FIG. 12 depicts a side view of the antenna in FIG. 11, from the side of arrow XII in FIG. 11;

FIG. 13 depicts a perspective view of the antenna and the position sensor of an actuator according to a further embodiment of the present invention;

FIG. 14 depicts a side, partial section view of the antenna and the position sensor in FIG. 13; and

FIG. 15 depicts a side view of the antenna in FIG. 14, from the side of arrow XV indicated in FIG. 14.

Elements or parts of elements common to the embodiments described below will be indicated by the same reference numerals.

### DETAILED DESCRIPTION OF THE INVENTION

With reference to the aforementioned figures, reference numeral 4 indicates, as a whole, an actuator for applications on parking brake module on vehicles, according to the present invention.

The actuator 4 comprises a body 8 containing at least partially a control rod 12 operatively connected to a motor 16 and to an actuating device 20 of a parking brake (not shown).

In one embodiment, the actuating device 20 is operatively connected to a parking brake of a motor vehicle. However, the aforesaid application is indicative and not exhaustive for the purposes of the present invention.

The body 8 delimits a containment volume 22 closed by a lid 26. For the purposes of the present invention, the body 8 and the lid 26 can have any shape and size; moreover, they can be made of several materials, including metal and plastic materials and combinations thereof.

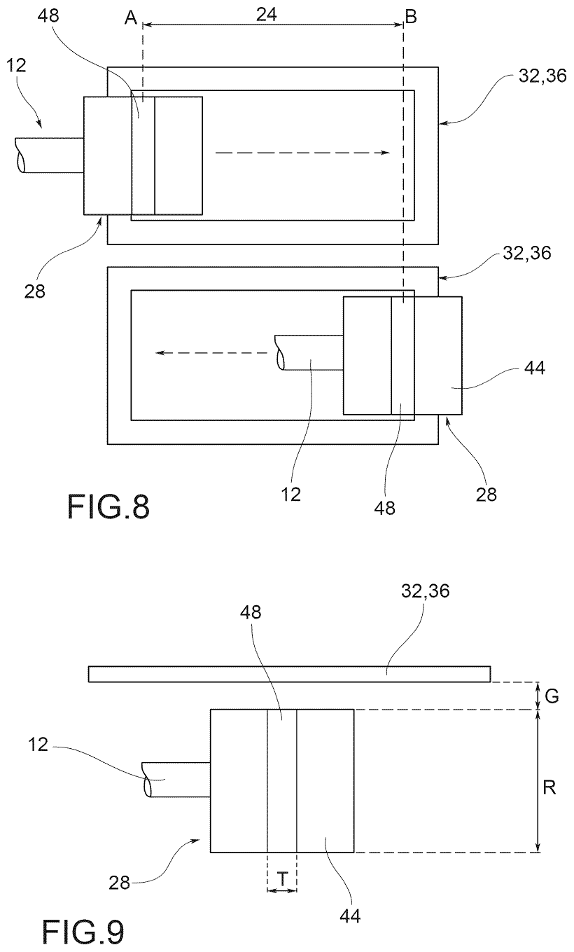

The motor 16 is configured to move the control rod 12 along an operating stroke 24 at least from a first position A to a second position B (FIG. 8). In one embodiment, the motor 16 may include electric motors, e.g., DC electric motors.

It is worth noting that, for the purposes of the present invention, the operating stroke 24 is not necessarily linear, but can also be curvilinear, can include a broken line, or even an alternation of curvilinear and straight segments.

For example, the control rod 12 is operatively connected to the motor 16 by kinematic mechanisms which can comprise screw-nut screw type couplings, gears, idlers, and the like.

Typically, the control rod 12 is provided with translational or roto-translational movement, the latter obtainable by a screw-nut screw type connection, for example.

The actuator 4 comprises an antenna 28 directly and integrally associated with the control rod 12. The antenna may be located inside the body 8, i.e., inside the containing volume 22. The antenna 28 can thus provide information on the position, i.e., on the operating condition, directly of the control rod 12, not of a component of the kinematic mechanism or the motor 16 themselves configured to move the control rod 12. In other words, it is possible to obtain a direct feedback on the position and thus on the operating condition of the control rod 12 which interfaces with the actuating device 20. This feedback unequivocally provides the operating condition of the actuating device 20 located downstream of the actuation chain which starts from the motor 16.

Therefore, it is possible to obtain an absolutely reliable feedback on the operating condition of the actuating device 20 but not of an intermediate kinematic mechanism as in the solutions of the prior art. Therefore, it is apparent that the feedback obtainable from this configuration is essential for the operation diagnostics of the apparatus arranged downstream of the actuating device 20.

The actuator 4 further comprises a position sensor 32 arranged, for example, on a printed circuit or PCB holder 36, housed inside the body 8, i.e., in the containment compartment 22, and facing the control rod 12 and the antenna 28. The position sensor 32 is of the active type and is powered by a power supply (not shown), which is typically, but not always, DC power supply.

The position sensor 32 is configured to detect the presence and position of the antenna 28, which, as seen, is associated directly and integrally with the control rod 12.

According to a possible embodiment, the sensor position 32 is arranged on the PCB support 36, e.g., parallel to the control rod 12.

The position sensor 32 is sized and positioned so as to cover and detect the position of the antenna 28 along the operating stroke 24, as shown in FIG. 8, for example, showing the antenna 28 in the first stroke-end position A and in the second stroke-end position B, respectively.

In one embodiment, the antenna 28 is arranged inside the body 8, i.e., inside the containment volume 22, between the motor 16 and the position sensor 32. The antenna 28 can thus always and immediately detect not only the position but also the very presence of the antenna 28 associated with the respective control rod 12.

Therefore, the system is entirely reliable and is capable of immediately detecting any anomaly downstream of the kinematic mechanism, hence any anomaly which directly affects the actuating device 20 the operation and/or operating condition of which must be monitored.

As used herein, the term, “anomaly” means both the detachment of the antenna 28 from the respective control rod 12, which event would be immediately detected by position sensor 32 which would no longer sense the presence of the antenna 28 itself, and an abnormal position of the antenna and hence an unsuitable operating configuration of the actuating device 20.

In one embodiment, the antenna 28 is fixed to an inner end 52 of the control rod 12, contained inside the body 8, i.e., in the containment volume 22, and the inner end 52 is located opposite to and integral with an outer end 56 which interfaces with the actuating device 20.

According to one possible embodiment, the antenna 28 is fixed on the control rod 12 by interference (press-fitting) and/or by gluing.

In one embodiment, the antenna 28 is keyed onto a portion of the control rod 12 provided with an external thread 60. The thread thus allows adjusting the axial position of the antenna 28 with respect to the control rod 12 by simply screwing the antenna 28 onto the threaded portion.

The external thread 60 also forms an axial undercut, i.e., it fixes the axial position of the antenna 28 with respect to the control rod 12. For this purpose, it is also possible to use special stops adapted to prevent a relative axial translation between the antenna 28 and the control rod, which would lead to an incorrect reading of the position or operating condition of the actuating device 20 by the position sensor 28.

As mentioned above, the control rod 12 can have any geometric shape and any relative actuation movement.

Preferably, but not exclusively, the control rod 12 has a main extension axis X-X and is movable along an axial direction parallel to the main extension axis X-X.

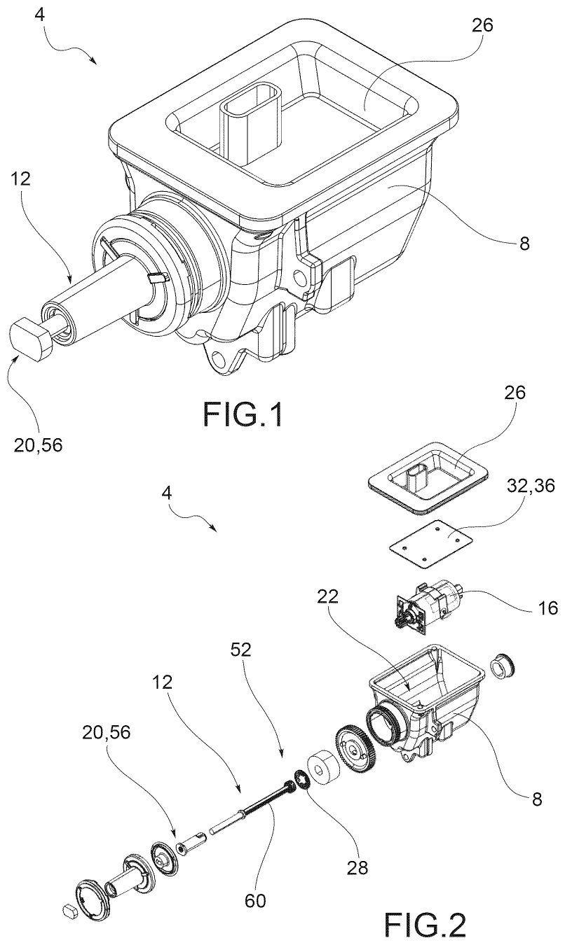

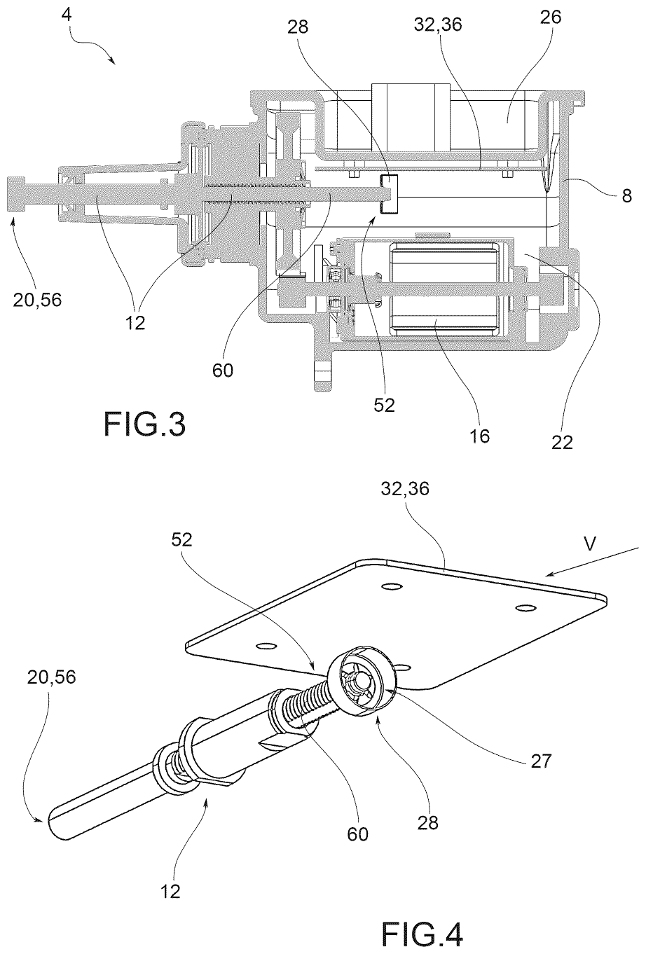

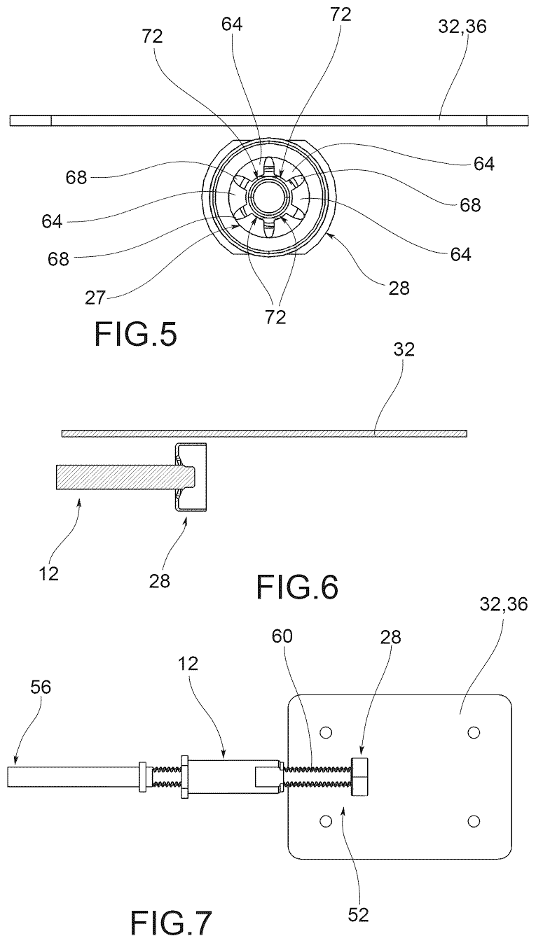

According to another possible embodiment (FIGS. 1-9), the antenna 28 may be axisymmetric with respect to the main extension axis X-X.

According to still another embodiment, the antenna 28 may be arranged coaxially to the control rod 12. As used herein, the term “coaxial arrangement” means that at least one portion 27 for fixing the antenna 28 to the control rod 12 is coaxial with the control rod 12 itself.

In one embodiment, the antenna 28 is a ring, at least partially made of metal and coaxial with the control rod 12. In addition, the antenna 28 may take the form of a single ring, made in one piece, coaxially keyed onto the control rod 12.

In one embodiment, the antenna 28 may be a Grifax® ring directly associated with the control rod 12.

The ring shaped antenna, for example of the Grifax® type, may include a plurality of radial teeth 64 mutually separated by grooves 68, and provided with end edges 72 in the shape of an arc of a circle. The radial teeth 64 thus interface with and are screwed onto the external thread 60 of the control rod 12.

As best shown in FIGS. 1-9, the ring can be axisymmetric with respect to the main extension axis X-X of the control rod 12 (. In such an axisymmetric configuration, the angular orientation of the ring is irrelevant.

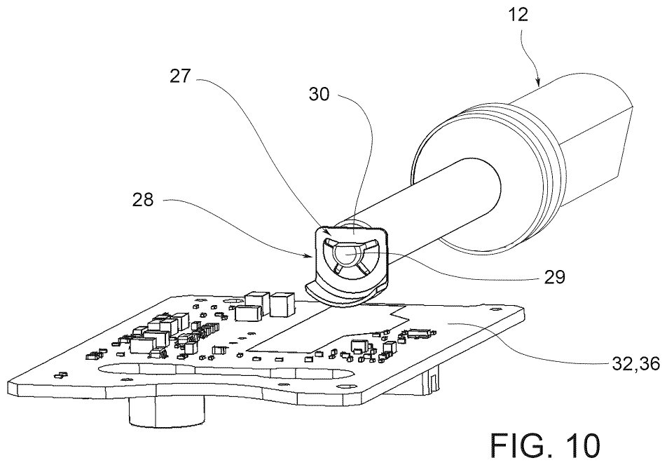

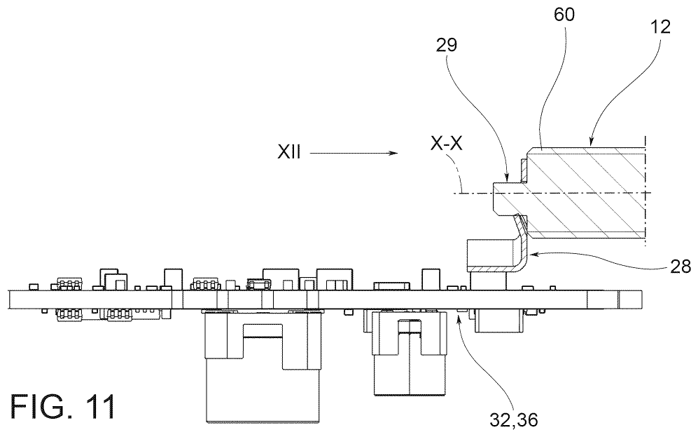

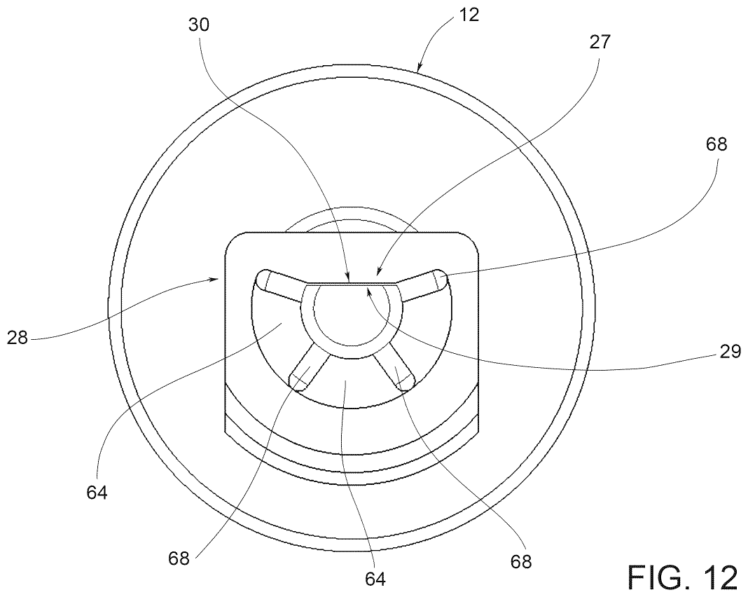

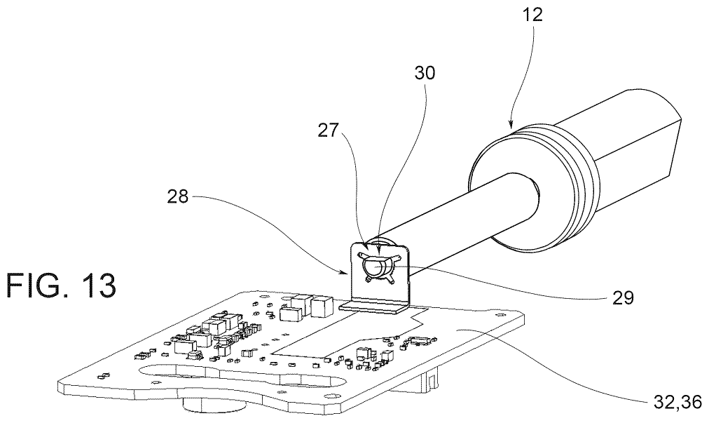

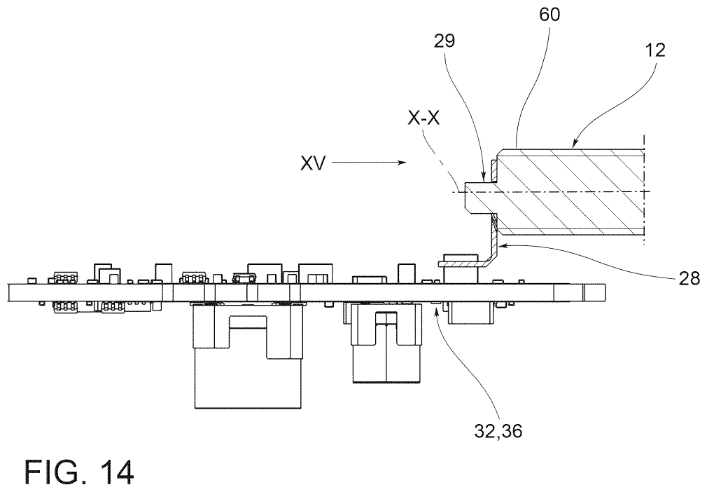

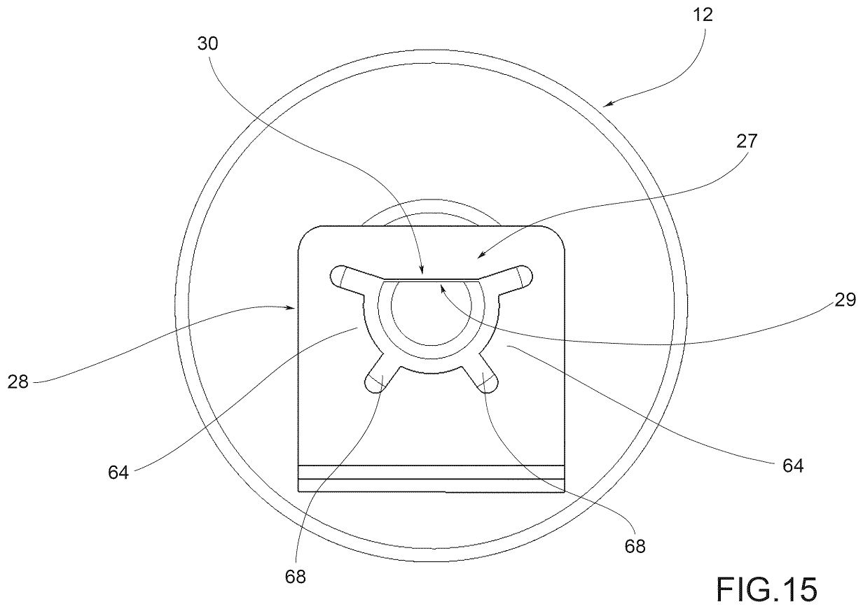

It is also possible to provide an asymmetric ring, as shown in FIGS. 10-15, for example, as the antenna 28. In such embodiments, there is a precise angular orientation of the asymmetric ring with respect to the control rod 12. Such an orientation is obtained, for example, by shape coupling between the control rod and the fixing portion 27 of the ring. For example, such a shape coupling comprises a flattening 29, made on the control rod 12, which couples to a flat abutment 30 obtained on the ring.

According to another possible embodiment, the antenna 28 comprises a cylindrical support 44 to which a metal portion 48 is folded and applied, e.g., by gluing, in the form of a metal foil. The metal foil 48 can also be applied as a metal coating, obtainable in various manners, including by PVD and/or CVD. In general, the metal portion can have any shape and thickness and can be applied to the control rod by bonding, interlocking, undercutting, welding, CVD, PVD, and the like.

In general, the antenna 28 may have a cylindrical shape about the main extension axis X-X, with a radius R greater than a distance or gap G from the position sensor 32.

The cylindrical shape is particularly useful when the operating stroke 24 of the control rod 12 and thus of the antenna 28 connected thereto is of the roto-translational type. Indeed, by virtue of the axial symmetry of the antenna 28, the risk that the position sensor 32 can take unreliable readings based on the actual angle of rotation of the antenna 28 during the operating stroke 24 is thus averted.

The antenna 28 may have an axial thickness T, parallel to the main extension axis X-X, greater than or equal to the gap G from the position sensor 32. Such a sizing always ensures the correct detection of the antenna 28 by the position sensor 32.

As can be appreciated from the description above, the present invention allows overcoming the drawbacks presented in the prior art.

In particular, the linear actuator according to the present invention is particularly reliable since it directly measures the position of the end component which interfaces with the parking mechanism.

Therefore, there is no indirect estimation of the actuator configuration, as in the solutions of the prior art, but rather a direct measurement of the position of the final component of the kinematic mechanism which engages or disengages the parking function.

Moreover, any detachment of the antenna from the related control rod is immediately detected by the position sensor located adjacent to the antenna.

The actuator is also particularly simple and inexpensive to manufacture and assemble.

Indeed, the antenna can be made using a very simple metal ‘Grifax’ ring, which is cost-effective and readily available in the market.

The assembly step is also particularly easy and cost-effective, because the ‘Grifax’ ring, or cylindrical antenna in general, can be immediately keyed onto the control rod. The antenna is thus self-supporting because, by virtue of the geometric shape thereof, is automatically supported by the control rod. Indeed, being fitted coaxially to the control rod, it forms a radial undercut with respect to the rod itself, which prevents it from detaching. In the case of breakage or detachment, as mentioned above, the antenna separates from the control rod, and its movement away from the control rod is immediately detected by the position sensor.

Therefore, the solution according to the present invention is perfectly ‘OBD-compliant’, unlike the solutions of the prior art.

Moreover, the use of a ring fitted and screwed directly onto the control rod also allows varying the axial position of the antenna with respect to the control rod and thus with respect to a different position of the position sensor. In other words, it is possible to vary the stroke-end positions by simply changing the axial position of the antenna with respect to the control rod, without requiring an ad hoc component to be manufactured.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

### LIST OF REFERENCE SIGNS

4: actuator
8: body
12: control rod
16: motor
20: actuating device
22: containment volume
24: operating stroke
26: lid
27: fixing position
28: antenna
29: flattening
30: flat abutment
32: position sensor
36: printed circuit or PCB holder
44: cylindrical support
48: metal portion
52: inner end
56: outer end
60: external thread
64: radial teeth
68: grooves
72: end edges
A: first position
B: second position
A: radius
G: gap
T: axial thickness
X-X: main extension axis

1. An actuator comprising:
a body at least partially containing a control rod operatively connected to a motor and to an actuating device of a parking brake, said motor being configured to move the control rod along an operating stroke at least from a first position to a second position,
an antenna directly and integrally associated with the control rod, said antenna being arranged inside the body,
a position sensor arranged on a printed circuit, housed inside the body and facing the control rod and the antenna, the position sensor being configured to detect the presence and position of said antenna.

2. The actuator as set forth in claim 1, wherein said control rod has a main extension axis and is movable along an axial direction parallel to said main extension axis.

3. The actuator as set forth in claim 2, wherein said antenna is axisymmetric with respect to said main extension axis.

4. The actuator as set forth in claim 1, wherein said antenna is arranged coaxially to the control rod.

5. The actuator as set forth in claim 1, wherein said antenna is a ring at least partially made of metal and coaxial with said control rod.

6. The actuator as set forth in claim 1, wherein said antenna is fixed to the control rod by interference and/or by gluing.

7. The actuator as set forth in claim 1, wherein the antenna is keyed and screwed onto a portion of the control rod provided with external thread.

8. The actuator as set forth in claim 1, wherein said antenna is a ring, such as a Grifax® ring, directly associated with the control rod.

9. The actuator as set forth in claim 8, wherein said ring comprises a plurality of radial teeth mutually separated by grooves, provided with end edges in the shape of an arc of a circle so as to be screwed onto the external thread of the control rod.

10. The actuator as set forth in claim 8, wherein said ring is axisymmetric with respect to said main extension axis of the control rod.

11. The actuator as set forth in claim 8, wherein said ring is axisymmetric and a specific angular orientation is provided between the ring and the control rod, obtained by shape coupling between a flattening, made on the control rod, which couples to a flat abutment obtained on the ring.

12. The actuator as set forth in claim 1, wherein said antenna comprises a cylindrical support onto which a metal portion is applied.

13. The actuator as set forth in claim 12, wherein said metal portion comprises a metal foil and/or metal coating applied by metal coating, bonding, interlocking, undercutting, welding, CVD, PVD and the like.

14. The actuator as set forth in claim 1, wherein the position sensor is arranged on a printed circuit parallel to said control rod.

15. The actuator as set forth in claim 1, wherein said antenna has a cylindrical shape about said main extension axis, with a radius greater than a distance or gap from the position sensor.

16. The actuator as set forth in claim 1, wherein said position sensor is sized and positioned so as to cover and detect the position of the antenna along said operating stroke.

17. The actuator as set forth in claim 1, wherein said control rod is provided with roto-translational movement.

18. The actuator as set forth in claim 1, wherein the antenna is arranged inside the body between the motor means and the position sensor.

19. The actuator as set forth in claim 1, wherein the antenna is fixed to an inner end of the control rod, contained inside the body, said inner end being opposite to and integral with an outer end which interfaces with said actuating device.

20. The actuator as set forth in claim 1, wherein the antenna has an axial thickness, parallel to the main extension axis, greater than or equal to the gap from the position sensor.

21. A parking brake comprising an actuator as set forth in claim 1.
